(19) United States
(12) Patent Application Publication
(10) Pub. No.: US 2022/0349793 A1
(43) Pub. Date: Nov. 3, 2022

(54) SYSTEMS AND METHODS FOR MATERIAL TEST SYSTEMS UTILIZING SHARED DATABASES

(71) Applicant: Illinois Tool Works Inc., Glenview, IL (US)

(72) Inventors: Roland Schaefer, Gurnee, IL (US); Sandra Straub, Bad Ditzenbach (DE); Matthias Pascher, Stuttgart (DE)

(21) Appl. No.: 17/733,006

(22) Filed: Apr. 29, 2022

Related U.S. Application Data
(60) Provisional application No. 63/182,481, filed on Apr. 30, 2021.

(51) Int. Cl. G01N 3/40

(52) U.S. Cl. CPC G01N 3/40; G01N 2203/0076; H04L 67/12

(57) ABSTRACT

Example networked material testing systems include: a database system storing a shared database, the shared database storing a material test procedure and material test result data; a first material test system communicatively coupled to the database system and configured to perform a first type of material test; and a second material test system communicatively coupled to the database system and configured to perform the first type of material test; wherein the database system comprises a computing device configured to execute machine readable instructions which cause the computing device to: transmit a first test program to the first material test system for performance of the first type of material test on a first specimen according to the first test program; store, in the shared database, first test result data received from the first material test system based on execution of the first test program; transmit a second test program to the second material test system for performance of the first type of material test on a second specimen according to the second test program; store, in the shared database, second test result data received from the first material test system or the second material test system based on execution of the second test program; and generate one or more test reports based on the first test program, the first material test system that performed the first test program, the second test program, and the second material test system that performed the second test program.

### RELATED APPLICATIONS

The present application claims the benefit of U.S. Provisional Patent Application Ser. No. 63/182,481, filed Apr. 30, 2021, entitled “SYSTEMS AND METHODS FOR MATERIAL TEST SYSTEMS UTILIZING SHARED DATABASES.” The entirety of U.S. Provisional Patent Application Ser. No. 63/182,481 is expressly incorporated herein by reference.

### BACKGROUND

The present disclosure relates to measurement equipment and, more particularly, to systems and methods for material test systems utilizing shared databases.

Limitations and disadvantages of conventional approaches will become apparent to one of skill in the art, through comparison of such approaches with some aspects of the present method and system set forth in the remainder of this disclosure with reference to the drawings.

### SUMMARY

Systems and methods for material test systems utilizing shared databases are disclosed, substantially as illustrated by and described in connection with at least one of the figures, and as set forth more completely in the claims.

### BRIEF DESCRIPTION OF THE DRAWINGS

These and/or other aspects will become apparent and more readily appreciated from the following description of the exemplary embodiments, taken in conjunction with the accompanying drawings.

FIG. 1 illustrates a block diagram of an example system having multiple material test system that utilize a shared database, in accordance with aspects of this disclosure.

FIG. 2 is a block diagram of an example computing system that may be used to implement the material test system and/or the example shared database system of FIG. 1.

FIG. 3 is a flowchart representative of example machine readable instructions that may be used to implement a computing device associated with a material test system to operate the material test system using a shared database.

FIG. 4 is a flowchart representative of example machine readable instructions that may be used to implement a computing device associated with shared database to generate reports for a multi-sample test procedure using multiple material test systems.

The figures are not necessarily to scale. Where appropriate, similar or identical reference numbers are used to refer to similar or identical components.

### DETAILED DESCRIPTION

Disclosed systems and methods provide for a shared database that may be used by multiple material test systems, such as material test systems that are connected via a network.

Conventionally, image recognition templates and test programs are only stored on the material test device on which the template or program was created. When a new sample (or batch) comes into a multiple-system lab using conventional material test systems, the samples would have to wait for a specific material test system to become available to proceed with the desired test(s). A conventional material test system may be unavailable for a new sample or batch because the material test system is in use, has an error, fails a periodic verification, and/or has a breakdown.

In contrast with conventional systems, disclosed systems and methods enable material test programs or procedures that are defined and stored on one material test system to be accessed by and/or shared with other connected material test systems via a shared, or central, database system. Using the shared database, the templates and programs from each tester are stored in the common, shared database. As a result, testing of new samples would not need to wait for a specific tester having a specific program. Instead, the next available tester could load the templates and/or programs necessary to test the new samples. Thus, disclosed systems and methods reduce bottlenecking, increase throughput of a lab, and/or reduce processing time for each sample.

Some parts or samples need multiple material tests that would require different types of equipment. Conventional material test systems performing multi-sample tests, involving performing tests on multiple material test systems, would further require interactions with each material test system to generate reports. Such individual report generation may further reduce the throughput of the material test systems and overall productivity of the lab. In contrast, disclosed systems and methods store results from each test or sample of a multi-sample test procedure in the shared database, which can then combine results from each material test system, sample, and/or test into a single procedure or job that contains all of the individual test or sample results, and automatically create a single, comprehensive report for the multi-sample test procedure.

In still other examples, a batch of production samples may need to be tested. In contrast with conventional material test systems in which each sample would have to wait for the appropriate turn at a specific material test system that has the right template and/or program, disclosed systems and methods may test multiple samples using the same templates and programs simultaneously, without conflicts between samples or test systems.

Example material test systems may include sectioning devices, mounting devices, grinder/polishers, hardness testers, imagers, and/or any other type of material testing and/or analysis equipment.

Disclosed example networked material testing systems include: a database system storing a shared database, the shared database storing a material test procedure and material test result data; a first material test system communicatively coupled to the database system and configured to perform a first type of material test; and a second material test system communicatively coupled to the database system and configured to perform the first type of material test; wherein the database system comprises a computing device configured to execute machine readable instructions which cause the computing device to: transmit a first test program to the first material test system for performance of the first type of material test on a first specimen according to the first test program; store, in the shared database, first test result data received from the first material test system based on execution of the first test program; transmit a second test program to the second material test system for performance of the first type of material test on a second specimen according to the second test program; store, in the shared database, second test result data received from the first material test system or the second material test system based on execution of the second test program; and generate one or more test reports based on the first test program, the first material test system that performed the first test program, the second test program, and the second material test system that performed the second test program.

In some example networked material testing systems, the first type of material test is a hardness test. In some example networked material testing systems, the first test program and the second test program are different test stages of a multi-sample material test procedure. In some example networked material testing systems, the first test program and the second test program are different instances of a same material test procedure.

In some example networked material testing systems, the machine readable instructions cause the computing device to transmit the first test program to the first material test system in response to a request from the first material test system. In some example networked material testing systems, the first material test system and the second material test system are coupled to the database system via a communications network.

In some example networked material testing systems, the machine readable instructions cause the computing device to store the test report in the shared database. In some example networked material testing systems, the machine readable instructions cause the computing device to select the first material test system based on at least one of: a status of the first material test system; a status of the second material test system; a test capability of the first material test system; or a queue of the first material test system. In some example networked material testing systems, the first material test system is further configured to perform a second type of material test.

10. The networked material testing system as defined in claim 1, wherein the first material test system and the second material test system are configured to utilize the shared database as though the shared database was a local database.

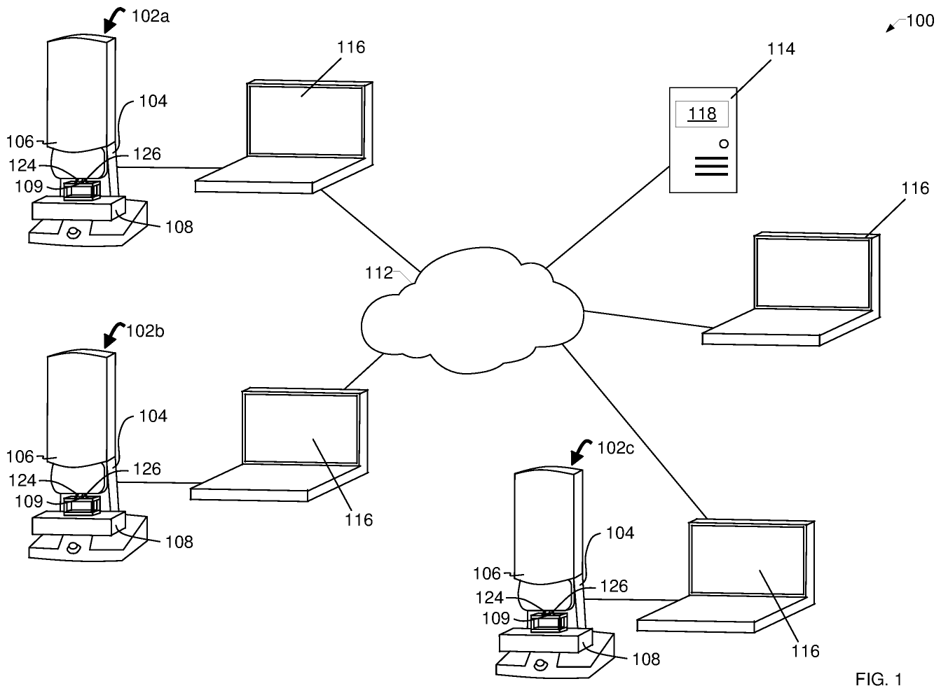

FIG. 1 illustrates a block diagram of an example system 100 having multiple material test systems 102a-102c that utilize a shared database. The example system 100 includes multiple material test systems 102a-102c. For the purposes of illustration, the example material test systems 102a-102c are hardness testers. However, any type(s), or combination of types, of material test systems 102a-102c may be used in a similar system.

Each of the example hardness testers 102a-102c includes a support frame 104, a test module 106, and a specimen stage 108. In the illustrated example, the support frame 104 supports the test module 106. The specimen stage 108 is also mounted to the support frame 104. A workpiece or specimen under test may be placed on the specimen stage 108 to undergo testing. The specimen stage 108 may be a movable stage that is motorized in the XY-directions, and/or may be controlled to enable auto sequencing of multiple samples, such as samples 109 shown. To this end, the specimen stage 108 may include an actuator configured to move the stage 108 in the X-Y directions.

The test module 106 includes an objective unit 124 and indenters 126. The test module 106 may further include elements such as a camera system (e.g., a digital camera that provides for navigation over the entire workpiece or specimen under test, and/or provides for accurate indent positioning). The objective unit 124 has a number of objectives to provide for multiple fields of view by changing (e.g., rotating) the objective unit 124 to position the desired objective with respect to the specimen stage 108. The objective unit 124 may be manually moved (e.g., rotated) by a user, or, may be moved by an actuator that is configured to rotate the objective unit 124 to an operating position, and/or to move the module 106 with respect to the specimen stage 108 (e.g., the Z-direction). Thus, the actuator may be controlled to move the indenters 126 into contact with a workpiece or specimen under test and to move the objectives and camera system towards and away from the workpiece or specimen during operation.

In some other examples, either or both of the stage 108 and the test module 106 may be configured to be moved by actuators in the X, Y, and/or Z directions, as desired. For example, in some examples, the stage 108 is configured to be moved in the Z direction. The test module 106 may be configured to be moved in the X-Y directions. In some examples, the stage 108 is a static stand, and actuators move the test module in the X, Y, and Z directions. Any desirable stage or stand, and any desired actuator(s), may be implemented to achieve proper positioning of the stage/stand and the test module with respect to one another. The system may also include additional components desired for the hardness testing system, such as a force sensor unit.

The hardness testers 102a-102c and/or the external computing device(s) 116 include control circuitry or a controller. The control circuitry or controller comprises circuitry (e.g., a microcontroller and memory such as a non-transitory machine-readable storage device) operable to receive and process data or control signals from a control unit, actuators, a camera system, a force sensor, and/or any other components of the hardness tester (or other material test system). and, in response, control the components of the hardness testing system. The control circuitry may include processor(s) and/or other logic circuitry that controls system operations. Example processor(s) may include one or more microprocessors, such as one or more “general-purpose” microprocessors, one or more special-purpose microprocessors and/or ASICS, one or more microcontrollers, and/or any other type of processing and/or logic device. For example, the controller may include one or more digital signal processors (DSPs).

The material test systems 102a-102c may be located in a same room or lab, in different rooms or labs in the same building, and/or in different buildings. In particular, the material test systems 102a-102c are connected to a same network 112 via wired and/or wireless connections. The network 112 may include one or more local area networks (LANs). For example, multiple local area networks may be connected via the Internet, such as by using a virtual private network (VPN) or other tunneling to securely couple different LANs.

The example system 100 further includes a database system 114 and an external computing device 116. The database system 114 implements and stores a shared database 118. As discussed in more detail below, the shared database 118 may store a material test procedures, test programs, material test result data, test images, templates, and/or other data that may be provided to and/or received from connected material test systems 102a-102c.

The database system 114 receives data from the material test systems 102a-102c. In some examples, the material test systems 102a-102c may transmit the data via the network 112. Additionally or alternatively, the material test systems 102a-102c may communicate directly with the database system 114. Example data that may be collected from the material test systems 102a-102c by database system 114 include identifiers (e.g., names, serial numbers, network addresses, media access control (MAC) addresses, etc.) of the material test systems 102a-102c, operating statuses (e.g., ready, error, paused, operating, etc.) of the material test systems 102a-102c, current operating cycle information (e.g., start time, stop time, remaining time in cycle) for the lab devices, error codes, time stamps, device connection status (e.g., connected to the database system 114, disconnected from the database system 114), parameters of the operating cycles performed by the material test systems 102a-102c, and/or test results from testing cycles performed by the material test systems 102a-102c. The material test systems 102a-102c may store test programs, parameters, and/or other data generated at a particular one of the material test systems 102a-102c, for subsequent use by other ones of the material test systems 102a-102c

Additionally or alternatively, the material test systems 102a-102c may request and receive data from the database system 114. For example, the material test systems 102a-102c may request templates for identifying samples based on their outlines. Additionally or alternatively, based on identifying a sample or part, the material test systems 102a-102c may request a test program including parameters, patterns, and/or other information. Depending on the sample or part, the database system 114 may determine that the requested program is part of a multi-sample program, and may select and assign to the requesting material test system 102a-102c one of multiple test programs in the multi-sample program.

Upon receipt of the test program, the material test system 102a-102c may store and/or perform the test program on the corresponding sample. The material test system 102a-102c then transmits the test result data to the database system 114 for storage, reporting generation, subsequent reference, and/or any other purpose. Example test result data may include sensor measurements, image data, derived measurements or data, identification and/or timestamp data, and/or any other information. In some examples, to conserve storage space at the database system 114, the material test systems 102a-102c may transmit certain data and store other data (e.g., image data, audio data, video data) locally at the material test system 102a-102c or transmit the other data to another system (e.g., cloud storage, network storage, a hard drive, etc.) for storage and/or subsequent retrieval as needed.

Example parameters for test programs may include consumable material feed rates, rotation speeds, applied force, pressure, temperature, process or recipe name, consumable supply, and/or any other parameters.

The example material test system 102a-102c send the data substantially in real-time and/or as batch data at frequent intervals and/or in response to events (e.g., the end of a test or procedure). Example intervals include any interval up to 24 hours, based on network connectivity for the transmitting material test system 102a-102c.

The external computing device(s) 116 may access the database system 114 and/or the material test systems 102a-102c. In some examples, the material test systems 102a-102c may be connected to a corresponding external computing device 116 to control the material test system 102a-102c, manage test data and/or programs, and/or otherwise control the material test system 102a-102c. The database system 114 may also be communicatively coupled to one or more external computing device(s) that are not associated with a particular material test system 102a-102c. Example external computing device(s) 116 may include a personal computer, a server, a smartphone, a laptop computer, a workstation, a tablet computer, and/or any other type of computing device. In some examples, the external computing device(s) 116 are communicatively connected to the database system 114 via the network 112, which may include one or more LANs, wireless local area networks (WLANs), wide area networks (WANs), and/or any other type(s) of networks.

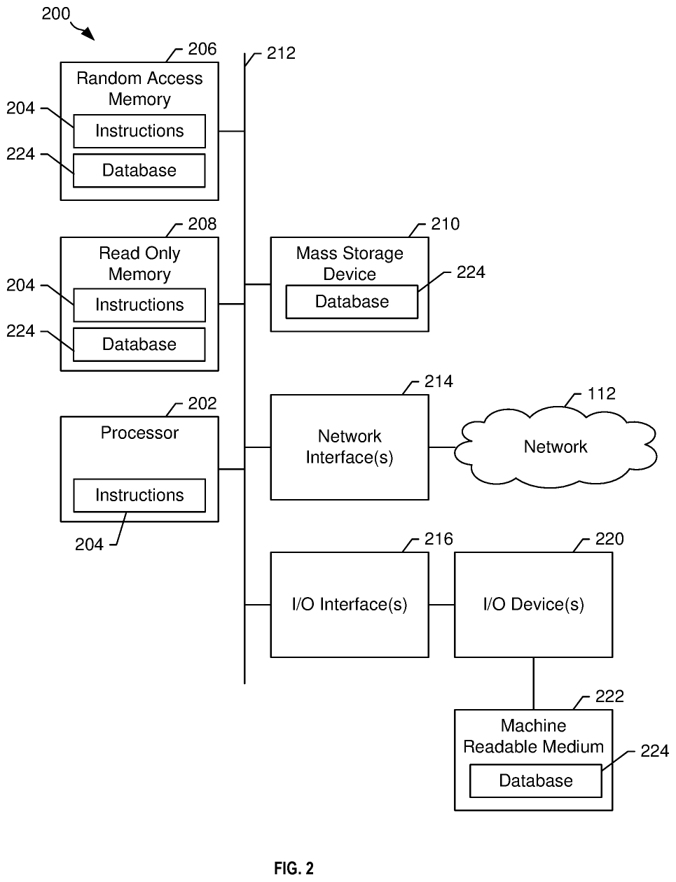

FIG. 2 is a block diagram of an example computing system 200 that may be used to implement the database system 114 and/or the example external computing system(s) 116 of FIG. 1. The example computing system 200 may be implemented using a personal computer, a server, a smartphone, a laptop computer, a workstation, a tablet computer, and/or any other type of computing device.

The example computing system 200 of FIG. 2 includes a processor 202. The example processor 202 may be any general purpose central processing unit (CPU) from any manufacturer. In some other examples, the processor 202 may include one or more specialized processing units, such as RISC processors with an ARM core, graphic processing units, digital signal processors, and/or system-on-chips (SoC). The processor 202 executes machine readable instructions 204 that may be stored locally at the processor (e.g., in an included cache or SoC), in a random access memory 206 (or other volatile memory), in a read only memory 208 (or other non-volatile memory such as FLASH memory), and/or in a mass storage device 210. The example mass storage device 210 may be a hard drive, a solid state storage drive, a hybrid drive, a RAID array, and/or any other mass data storage device.

A bus 212 enables communications between the processor 202, the RAM 206, the ROM 208, the mass storage device 210, a network interface 214, and/or an input/output interface 216.

The example network interface 214 includes hardware, firmware, and/or software to connect the computing system 200 to the communications network 112 of FIG. 1. For example, the network interface 214 may include IEEE 202.X-compliant wireless and/or wired communications hardware for transmitting and/or receiving communications.

The example I/O interface 216 of FIG. 2 includes hardware, firmware, and/or software to connect one or more input/output devices 220 to the processor 202 for providing input to the processor 202 and/or providing output from the processor 202. For example, the I/O interface 216 may include a graphics processing unit for interfacing with a display device, a universal serial bus port for interfacing with one or more USB-compliant devices, a FireWire, a field bus, and/or any other type of interface. Example I/O device(s) 220 may include a keyboard, a keypad, a mouse, a trackball, a pointing device, a microphone, an audio speaker, an optical media drive, a multi-touch touch screen, a gesture recognition interface, a display device, a magnetic media drive, and/or any other type of input and/or output device.

The example computing system 200 may access a non-transitory machine readable medium 222 via the I/O interface 216 and/or the I/O device(s) 220. Examples of the machine readable medium 222 of FIG. 2 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

Example wireless interfaces, protocols, and/or standards that may be supported and/or used by the network interface(s) 214 and/or the I/O interface(s) 216, include wireless personal area network (WPAN) protocols, such as Bluetooth (IEEE 202.15); near field communication (NFC) standards; wireless local area network (WLAN) protocols, such as WiFi (IEEE 202.11); cellular standards, such as 2G/2G+ (e.g., GSM/GPRS/EDGE, and IS-95 or cdmaOne) and/or 2G/2G+ (e.g., CDMA2000, UMTS, and HSPA); 4G standards, such as WiMAX (IEEE 202.16) and LTE; Ultra-Wideband (UWB); etc. Example wired interfaces, protocols, and/or standards that may be supported and/or used by the network interface(s) 214 and/or the I/O interface(s) 216, such as to communicate with the display device(s), include comprise Ethernet (IEEE 202.3), Fiber Distributed Data Interface (FDDI), Integrated Services Digital Network (ISDN), cable television and/or internet (ATSC, DVB-C, DOCSIS), Universal Serial Bus (USB) based interfaces, etc.

The processor 202, the network interface(s) 214, and/or the I/O interface(s) 216 may perform signal processing operations such as, for example, filtering, amplification, analog-to-digital conversion and/or digital-to-analog conversion, up-conversion/down-conversion of baseband signals, encoding/decoding, encryption/decryption, modulation/demodulation, and/or any other appropriate signal processing.

The computing system 200 may use one or more antennas for wireless communications and/or one or more wired port(s) for wired communications. The antenna(s) may be any type of antenna (e.g., directional antennas, omnidirectional antennas, multi-input multi-output (MIMO) antennas, etc.) suited for the frequencies, power levels, diversity, and/or other parameters required for the wireless interfaces and/or protocols used to communicate. The port(s) may include any type of connectors suited for the communications over wired interfaces/protocols supported by the computing system 200. For example, the port(s) may include an Ethernet over twisted pair port, a USB port, an HDMI port, a passive optical network (PON) port, and/or any other suitable port for interfacing with a wired or optical cable.

One or more of the RAM 206, the ROM 208, the mass storage device 210, and/or the machine readable medium 222 may store or otherwise include a database 224. The database 224 may be a local database which is periodically copied to the database system 114 for inclusion in the shared database 118 of FIG. 1. In some examples, the processor 302 treats the shared database 118 as an extension or part of the local database 224, through communications with the database system 114 via the network interface(s) 314.

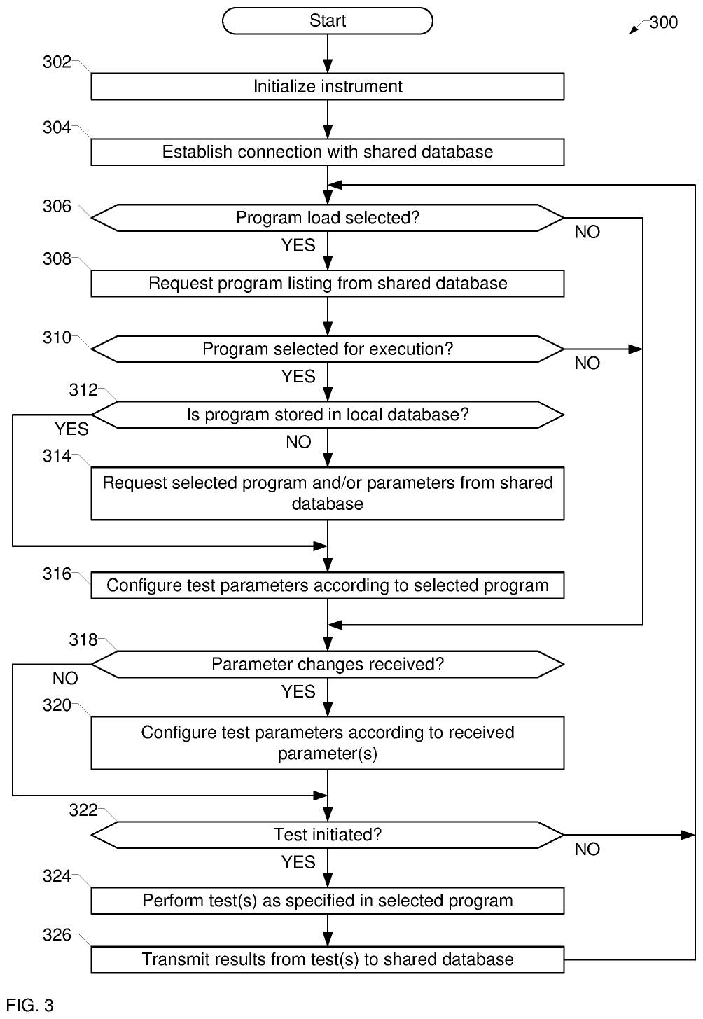

FIG. 3 is a flowchart representative of example machine readable instructions 300 that may be used to implement the external computing device 116 associated with a material test system 102a, to operate the material test system 102a using a shared database 118. The example instructions 300 are described below with reference to the computing system 200 of FIG. 2, which may implement the external computing device 116 associated with the material test system 102a.

At block 302, the processor 202 initializes the instrument (e.g., the material test system 102a). For example, the processor 202 establish a connection with control circuitry of the material test system 102a, perform calibrations, diagnostics, and/or other procedures prior to performing tests. At block 304, the processor 202 establishes a connection with the shared database 118 (e.g., the database system 114, via the network interface(s) 214). For example, the processor 202 may register or provide authentication details to the database system 114 via the network 112.

At block 306, the processor 202 determines whether loading of a program has been selected (e.g., via a user interface). If loading of a program has been selected (block 306), at block 308 the processor 202 requests a program listing from the shared database (e.g., from the database system 114). The program listing may include all available test programs, test programs meeting one or more specific criteria, and/or any other listing. Example criteria may be based on the types of tests that can be performed by the material test system 102a, tests based on an identified sample, and/or any other criteria.

At block 310, the processor determines whether a program has been selected for execution. For example, an operator may select one of a listing of programs presented on a user interface, and/or a program may be automatically selected based on matching an outline of a sample to a template. If a program has been selected (block 310), at block 312 the processor 202 determines whether a program is stored in the local database 226. If the program is not stored in the local database (block 312), at block 314 the processor 202 requests the selected program and/or parameters from the shared database (e.g., from the database system 114 via the network 112). In some examples, blocks 312 and 314 may be omitted, and the program may always be retrieved from the shared database 118. Consistently retrieving the programs from the shared database 118 may reduce errors or mismatches in program versions.

If the program is stored in the local database (block 312), or after requesting the selected program from the shared database 118 (block 314), at block 316 the processor 202 configures the test parameters according to the selected program.

After configuring the test parameters (block 316), if loading of a program has not been selected (block 306), or if a program has not been (block 310), at block 318 the processor 202 determines whether any parameter changes have been received. For example, the processor 202 may receive manual changes to a configured program via a user interface. In some examples, changes to a program loaded from the shared database 118 may cause a notification of the change to be provided to the database system 114 for notation and/or storage. In some examples, programs may be designated to disallow certain changes, or any changes, to a program. If parameters changes have been received (block 318), at block 320 the processor 202 configures the test parameters according to the received parameters.

After configuring the test parameters (block 320), or if parameter changes have not been received (block 320), at block 322 the processor 202 determines whether the test has been initiated. For example, the test may be automatically or manually initiated. If a test has not been initiated (block 322), control returns to block 306 to continue configuration.

When a test is initiated (block 322), at block 324 the processor 202 controls the material testing system 102a to perform one or more test(s) as specified in the selected and configured test program. At block 326, the processor 202 transmits results of the test(s) to the shared database 118. Control then returns to block 306 to configure subsequent tests, or the instructions 300 may then end.

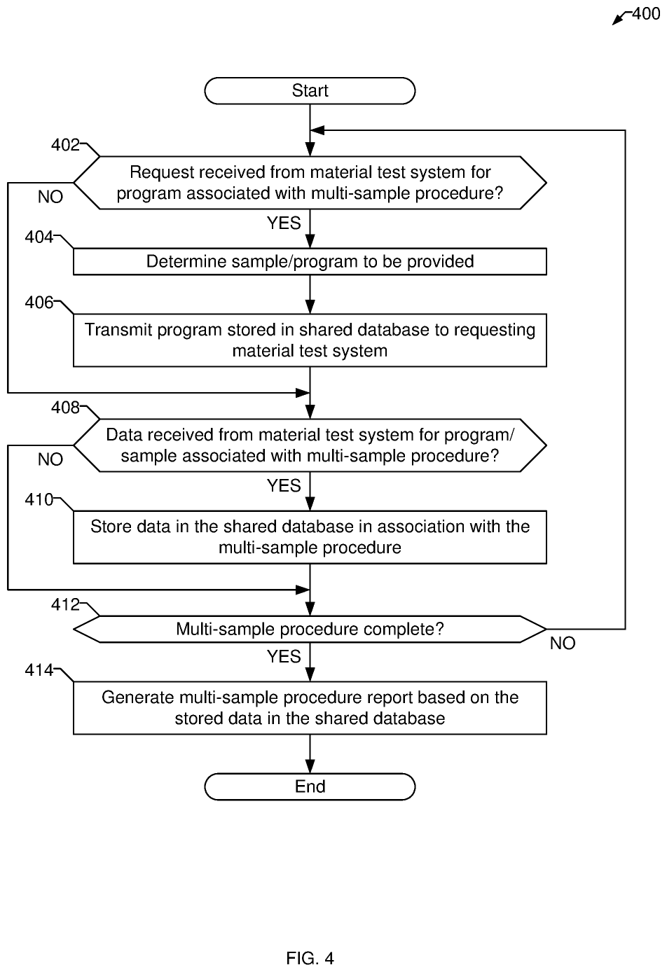

FIG. 4 is a flowchart representative of example machine readable instructions 400 that may be used to implement a computing device associated with shared database to generate reports for a multi-sample test procedure using multiple material test systems. For example, the instructions may be performed by the computing system 200 of FIG. 2 implementing the database system 114 of FIG. 1.

At block 402, the processor 202 determines whether a request has been received from a material test system 102a-102c for a program associated with a multi-sample procedure. For example, the database system 114 may receive a request based on matching a template to a sample, based on manual selection of a multi-sample program, and/or any other request for a test program. A multi-sample procedure may include multiple test programs to be performed on one or more corresponding samples by the material test systems 102a-102c in the system 100. Because the test programs for the multi-sample procedure are stored in the shared database 118 and may be provided to any capable one of the material test systems 102a-102c, the multi-sample procedure is more resistant to productivity bottlenecks due to having to wait for a particular material test system 102a-102c to perform a given test program.

The database system 114 may provide different test programs to different material test systems 102a-102c based on the requirements of the samples to be tested and/or the defined procedures. In some examples, test programs provided to different material test systems 102a-102c are different test stages of a same multi-sample material test procedure. In some examples, test programs provided to different material test systems 102a-102c are different instances of a same material test procedure.

If a request has been received for a program associated with a multi-sample procedure (block 402), at block 404 the processor 202 determines a sample or program to be provided in response to the request. For example, the processor 202 may determine the program based on a user interface, via an automatic detection based on an outline of a sample, based on the capabilities of the requesting system, based on which test programs in the multi-sample procedure have already been performed, and/or any other criteria. At block 406, the processor 202 transmits the determined program stored in the shared database 118 to the requesting material test system 102a-102c.

After transmitting the program (block 406), or if a request for a program associated with a multi-sample procedure has not been received (block 402), at block 408 the processor 202 determines whether data has been received from a material test system 102a-102c for a program or sample associated with a multi-sample procedure. For example, the material test system 102a-102c may provide test results or data to the database system 114 for storage in the shared database 118. If data has been received for a program or sample associated with a multi-sample procedure (block 408), at block 410 the processor 202 stores the data in the shared database 118 in association with the multi-sample procedure.

After storing the data (block 410), or if has been received for a program or sample associated with a multi-sample procedure (block 408), at block 412 the processor 202 determines whether the multi-sample procedure is complete. For example, the processor 202 may determine whether there are additional test programs and/or samples to be tested in the multi-sample procedure. If the multi-sample procedure is not complete (block 412), control returns to block 402.

When the multi-sample procedure is complete (block 412), at block 414 the processor 202 generates a multi-sample procedure report based on the stored data in the shared database 118. The multi-sample procedure report may be generated based on the test programs, the results, the material test systems 102a-102c that performed each of the test programs and generated the results, the operators, the sample information, and/or any other desired information. By generating the report at the database system 114 (or an external computing device 116 not directly associated with one of the material test systems 102a-102c), the material test systems 102a-102c may continue to be used while reports are being generated using the data stored in the shared database 118.

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine readable storage media and to exclude propagating signals.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A networked material testing system, comprising:
a database system storing a shared database, the shared database storing a material test procedure and material test result data;
a first material test system communicatively coupled to the database system and configured to perform a first type of material test; and
a second material test system communicatively coupled to the database system and configured to perform the first type of material test;
wherein the database system comprises a computing device configured to execute machine readable instructions which cause the computing device to:
transmit a first test program to the first material test system for performance of the first type of material test on a first specimen according to the first test program;
store, in the shared database, first test result data received from the first material test system based on execution of the first test program;
transmit a second test program to the second material test system for performance of the first type of material test on a second specimen according to the second test program;
store, in the shared database, second test result data received from the first material test system or the second material test system based on execution of the second test program; and
generate one or more test reports based on the first test program, the first material test system that performed the first test program, the second test program, and the second material test system that performed the second test program.

2. The networked material testing system as defined in claim 1, wherein the first type of material test comprises a hardness test.

3. The networked material testing system as defined in claim 1, wherein the first test program and the second test program are different test stages of a multi-sample material test procedure.

4. The networked material testing system as defined in claim 1, wherein the first test program and the second test program are different instances of a same material test procedure.

5. The networked material testing system as defined in claim 1, wherein the machine readable instructions cause the computing device to transmit the first test program to the first material test system in response to a request from the first material test system.

6. The networked material testing system as defined in claim 1, wherein the first material test system and the second material test system are coupled to the database system via a communications network.

7. The networked material testing system as defined in claim 1, wherein the machine readable instructions cause the computing device to store the test report in the shared database.

8. The networked material testing system as defined in claim 1, wherein the machine readable instructions cause the computing device to select the first material test system based on at least one of: a status of the first material test system; a status of the second material test system; a test capability of the first material test system; or a queue of the first material test system.

9. The networked material testing system as defined in claim 1, wherein the first material test system is further configured to perform a second type of material test.

10. The networked material testing system as defined in claim 1, wherein the first material test system and the second material test system are configured to utilize the shared database as though the shared database was a local database.
